(19) United States
(12) Patent Application Publication
(10) Pub. No.: US 2006/0269684 A1
(43) Pub. Date: Nov. 30, 2006

(54) METHOD FOR MAKING HARDENED WOOD

(76) Inventors: Timothy Lloyd Presnell, Mount Pleasant, SC (US); Louis Joseph Tortorelli, Talbott, TN (US); Frederick Eugene Bishop JR., Charleston, SC (US)

Correspondence Address: MEADWESTVACO CORPORATION, REGIONAL OFFICE BUILDING, PO BOX 118005, CHARLESTON, SC, 29423-8005, US

(21) Appl. No.: 11/462,417

(22) Filed: Aug. 4, 2006

Related U.S. Application Data
(63) Continuation-in-part of application No. 10/993,440, filed on Nov. 22, 2004.
Application No. 10/993,440 is a continuation-in-part of application No. 10/738,309, filed on Dec. 17, 2003, now abandoned.

(51) Int. Cl. B05D 1/18; A41G 1/00

(52) U.S. Cl. 427/440; 428/17

(57) ABSTRACT

This invention relates to a method for making hardened wood by treating wood with acrylic/rosin/fatty acid-based formulations. Furthermore, the invention relates to a method for treating non-heartwood pine with acrylic/rosin/fatty acid-based formulations in order to give the treated non-heartwood pine the aesthetic appearance similar to that exhibited by yellow pine heartwood and the hardness similar that exhibited by oak.

This is a continuation-in-part application of co-pending and commonly assigned U.S. application Ser. No. 10/993,440 filed on Nov. 22, 2004, which is a continuation-in-part application of U.S. application Ser. No. 10/738,309 filed on Dec. 17, 2003, now abandoned.

### FIELD OF INVENTION

This invention relates to a method for making hardened wood by treating wood with acrylic/rosin/fatty acid-based formulations. Furthermore, the invention relates to a method for treating non-heartwood pine with acrylic/rosin/fatty acid-based formulations in order to give the treated non-heartwood pine the aesthetic appearance similar to that exhibited by yellow pine heartwood and the hardness similar that exhibited by oak.

### BACKGROUND OF THE INVENTION

The wood flooring market constitutes millions of board feet of lumber cut from high-quality hardwood and softwood species. While there are other types of wood used for flooring, oak is a prominent wood for this market. In addition to pricing, another primary advantageous feature of oak flooring is its hardness that withstands traffic wear and marring by foot and mechanical traffic.

Several methods have been used to improve hardness of wood and lumber. Mechanical force is commonly used to enhance the hardness property through densification. U.S. Pat. No. 5,937,925 disclosed the use of microwave energy to compress the wood volume by at least 70%. Wood such as pine was exposed to microwave energy in order to forcibly eliminate water inside the wood and to make the wood tissue soft. Subsequently, the softened wood was compressed using a hydraulic press. The strength and hardness of the compressed wood improved by about 30 times relative to the original wood, and tensile strength was increased by about up to 10 times. WO Patent Application No. 96/26,054 taught the improvement of wood hardness through densification and impregnation. Wood such as pine was pressed isostatically with a pressure exceeding 1,000 bars, followed by immersing in a bath containing a liquid-impregnating agent. The dimension of wood was normally reduced by about 20% to 50%. U.S. Pat. No. 6,267,920 used hydrostatic compression method to enhance wood hardness as well as external appearance. The wood in the softened state was compressed with hydrostatic pressure using liquid as the pressuring medium, followed by treating with a fixative means to fix the compressed state.

Polymer is typically used for impregnation of wood to enhance hardness. Wood is first impregnated with monomers, followed by in situ polymerization of the monomers within the wood. WO Patent Application No. 02/43,933 impregnated wood with a solution of furfuryl alcohol, followed by hot pressing the wood under conditions to initiate the polymerization of furfuryl alcohol within the wood. In U.S. Pat. No. 6,194,078, the hardened wooden flooring products were obtained by impregnating wooden material with a hardener in a pressure vessel. A solution containing methyl methacrylate monomers was used as a hardening agent, which was polymerized within the wood through free radical polymerization. In U.S. Pat. No. 3,765,934, a solution of styrene and maleic acid monomers were used as an impregnating agent that was polymerized within the wood through high-energy radiation or thermal decomposition of a free radical initiator.

It would, therefore, be economically advantageous to have an efficient and inexpensive process for improving the hardness of wood without the requirement of extensive high pressure or in situ polymerization.

It is an object of the present invention to provide a method for improving the hardness of wood.

In some parts of the southeastern U.S., there is demand for the heartwood from the center of old southern pine trees in the wooded flooring application. The main driver for demand is its aesthetic yellowish-to-reddish color and resinous surface appearance. Nevertheless, its use is quite limited compared to oak wooded flooring; due to its inferior hardness it does not withstand traffic wear and marring.

Heartwood, as the name implies, comes from the inner part of the tree trunk. It is wood that is essentially dead, whose cells have begun to fill with resinous material. Current forest management practices lead to most pine trees being harvested while they are relatively young, at a growth stage wherein the trees contain little or no heartwood. Therefore the commercial supply of heartwood pine is more or less limited to the few stands of old forest that can still be found and lumber recycled from the disassembly of old buildings and other structures. This leads to pine heartwood being several times more expensive than readily available non-heartwood pine. In spite of its relatively low cost, non-heartwood pine finds limited use in flooring application since it is easily marred due to its softness. Furthermore, it lacks the rich color of the heartwood of old growth pine. Therefore, its use is typically relegated to less decorative applications such as structural timbers and outdoor decking.

It would, therefore, be economically advantageous to have an efficient and inexpensive process for treating non-heartwood pine so that it displays the physical and aesthetic properties similar to those exhibited by old growth pine heartwood. In U.S. patents application Ser. No. 10/993,440, which are incorporated herein by reference, non-heartwood pine was treated with rosin or a rosin derivative to simulate the physical and aesthetic properties of pine heartwood.

It is an object of the present invention to provide a method for treating non-heartwood pine so that it displays the aesthetic appeal similar to that exhibited by old growth pine heartwood, while achieving the hardness level approximately of oak.

Another object of the present invention is to provide a method for producing hardened wood from non-heartwood wood.

Other objects and advantages of the present invention will become apparent from the following detailed description.

### SUMMARY OF THE INVENTION

The objectives of this invention are met by a process that impregnates wood with acrylic/rosin/fatty acid-based formulation. Furthermore, when non-heartwood pine is used for the process, the hardened pine exhibits aesthetic appearance similar to those possessed by naturally occurring pine heartwood, and hardness approaching that level of oak.

### DESCRIPTION OF THE PREFERRED EMBODIMENT

A process for producing hardened wood of the present invention comprising the step of impregnating wood part by immersing the wood part at ambient temperature in a hardening liquid formulation, wherein the non-volatile content of the liquid formulation comprises:
(a) from about 40% to 100% by weight of a low molecular weight acrylic polymer; and
(b) up to about 60% by weight of a rosin/fatty acid derivative, wherein the derivative comprises about 40% to 100% of a rosin or a rosin derivative and about 0% to 60% of a fatty acid or a fatty acid derivative.
   The non-volatile content of the formulation is from about 15% to 30%, preferably from 20% to 30%, and more preferably from 25% to 30%. After immersing in the hardening liquid formulation, the treated wood is dried to a moisture content of less than 12%.

A preferred embodiment of the invention is a process for producing hardened wood of the present invention comprising the step of impregnating wood part by immersing the wood part at ambient temperature in a hardening liquid formulation, wherein the non-volatile content of the liquid formulation comprises:
(a) from about 40% to 100% by weight of a low molecular weight acrylic polymer; and
(b) up to about 60% by weight of a rosin/fatty acid derivative, wherein the derivative comprises about 50% to 90% of a rosin or a rosin derivative and about 10% to 50% of a fatty acid or a fatty acid derivative.
   The non-volatile content of the formulation is from about 15% to 30%, preferably from 20% to 30%, and more preferably from 25% to 30%. After immersing in the hardening liquid formulation, the treated wood is dried to a moisture content of less than 12%.

The term “wood” in the present invention refers to heartwood, non-heartwood, and a combination thereof. Woods suitable for use in the present invention may be obtained from any trees including, but are not limited to, Pinus, Prunus, Acer, and Quercus. Non-heartwood pine which is suitable for use in the present invention may be obtained from any tree of the Pinaceae family including the following generae: Abies, Cathaya, Cedrus, Keteleeria, Larix, Nothotsuga, Picea, Pinus, Pseudolarix, Pseudotsuga, and Tsuga. It is preferred to use non-heartwood pine from a member selected from the group consisting of Pinus palustris, P. echinata, P. taeda, P. elliottii, P. serotina, and hybrids thereof.

In the context of the present invention the term “wood part” relates to any wooden article, such as flooring strips, furniture parts, boards, beams, panels, veneers, frames, and construction elements.

Low molecular weight acrylic polymer of the present invention has a weight average molecular weight of from 2,000 to 16,500, preferably from 5,000 to 11,000, and more preferably from 7,500 to 9,000. The acid number of the acrylic polymer is preferably from 50 to 280, and more preferably from 150 to 235. Aqueous bases suitable for use in neutralizing these acrylic polymers include, but are not limited to, organic and inorganic compounds such as sodium hydroxide, potassium hydroxide, ammonium hydroxide, amines, sulfates, and the like.

Preferred low molecular weight acrylic polymers include members selected from the group consisting of the polymerization reaction product of: (i) a member selected from the group consisting of acrylic acid, methacrylic acid, fumaric acid, crotonic acid, itaconic acid, maleic acid, maleic anhydride, carboxylic acrylics, and combinations thereof, and (ii) a member selected from the group consisting of vinylic monomer and combinations thereof.

Vinylic monomers suitable for use in the present invention include, but are not limited to, styrenic monomer, acrylic monomers, methacrylic monomers, ethylenic monomers, and the like. The term “acrylic monomer” as employed herein includes members of the group consisting of acrylic acid, methacrylic acid, acrylic acid esters, methacrylic acid esters, derivatives of acrylic acid, derivatives of methacrylic acid, and mixtures thereof. Examples of suitable acrylic acid ester and methacrylic acid ester monomers include the C₁-C₃₀ alkyl ester derivatives.

Derivatives of acrylic acid monomer suitable for use in the present invention include acrylic acid and its salts, acrylonitrile, acrylamide, methyl alpha-chloroacrylate, methyl 2-cyanoacrylate, N-ethylacrylamide, N,N-diethylacrylamide acrolein, and the like.

Derivatives of methacrylic acid monomer suitable for use in the present invention include methacrylic acid and its salts, methacrylonitrile, methacrylamide, N-methylmethacrylamide, N-ethylmethacrylamide, N,N-diethymethacrylamide, N,N-dimethylmethacrylamide, N-phenyl-methacrylamide, methacrolein, and the like.

Examples of suitable low molecular weight acrylic polymers for the present invention include, but are not limited to, Morez 101 commercially available from Rohm & Haas, Soluryl S-70 from Hanwha Chemical Corporation (Korea), H-2720 resin from MeadWestvaco, and the copolymers taught in U.S. Pat. Nos. 4,414,370 and 4,529,787 which are incorporated herein by reference. Preferably the low molecular weight acrylic polymer is a styrene/acrylic copolymer.

Rosins that are suitable for use in the present invention include tall oil rosin, gum rosin, wood rosin, and combinations thereof. Rosin derivatives that are suitable for use in the process of the invention include, but are not limited to, the following: hydrogenated rosins, disproportionated rosins, formaldehyde-treated rosins, dimerized rosins, polymerized rosin, fumarated rosins, maleated rosins, styrenated rosins, phenolic-modified rosins, acrylic-modified rosins, hydrocarbon-modified rosins, rosin-vinylic copolymers, rosin salts, hydrogenated rosin salts, disproportionated rosin salts, formaldehyde-treated rosin salts, dimerized rosin salts, polymerized rosin salts, fumarated rosin salts, maleated rosin salts, styrenated rosin salts, phenolic-modified rosin salts, acrylic-modified rosin salts, hydrocarbon-modified rosin salts, rosin-vinylic copolymer salts, rosin esters, hydrogenated rosin esters, disproportionated rosin esters, formaldehyde-treated rosin esters, dimerized rosin esters, polymerized rosin esters, fumarated rosin esters, maleated rosin esters, styrenated rosin esters, phenolic-modified rosin esters, acrylic-modified rosin esters, hydrocarbon-modified rosin esters, rosin-vinylic copolymer esters, rosin amides, hydrogenated rosin amides, disproportionated rosin amides, formaldehyde-treated rosin amides, dimerized rosin amides, polymerized rosin amides, fumarated rosin amides, maleated rosin amides, styrenated rosin amides, phenolic-modified rosin amides, acrylic-modified rosin amides, hydrocarbon-modified rosin amides, rosin-vinylic copolymer amides, and combinations thereof. Rosin-vinylic copolymers which are suitable for use in the invention include those taught in U.S. Pat. No. 6,437,033, which is herein incorporated by reference. Suitable rosin amides include those taught in U.S. Pat. Nos. 5,066,331 and 5,152,832, which are incorporated herein by reference. Preferred rosin derivatives for the present invention are fumarated rosins and maleated rosins.

Dispersions of rosin and/or rosin derivatives (and, where desired, additive resinous materials) which are suitable for use in the present invention are liquid at ambient temperature and may be impregnated into the wood parts in that form. In the context of the present invention, the term “ambient temperature” is typically a temperature in the range of about −25° C. to about 40° C.

Alternatively, the rosin and/or rosin derivative (and, where desired, additive resinous materials) can be dissolved in a suitable organic solvent and impregnated into the wood parts in a liquid solution form at ambient temperature. Rosins, most rosin derivatives, and most of the additive resinous materials are soluble in relatively inexpensive aliphatic or aromatic hydrocarbon solvents such as mineral spirits, toluene, or xylene. However, where desired more polar solvents (such as esters, alcohols, ketones, and the like) may also be used. The solvents used should be sufficiently volatile so that they evaporate readily from the treated wood. The lower viscosity and dynamic surface tension of the liquid solutions relative to the liquid dispersions allow for more rapid penetration of the immersed wood parts.

Rosins, high acid number rosin derivatives (such as hydrogenated rosins, disproportionated rosins, dimerized rosins, maleated rosins, fumarated rosins, and partial esters of maleated or fumarated rosins with various polyols known in the art as soluble maleic resins), and some of the additive resinous materials (such as fatty acids, dimer acids, water-reducible alkyd resins, and the like) are soluble in water in the presence of aqueous bases such as alkali metal hydroxides or carbonates, ammonia, low molecular weight alkylamines or alkanolamines, and the like. These materials can therefore be impregnated into the immersed wood part as aqueous liquid solutions. Alkylamines containing from one to about six carbon atoms are suitable for use in solubilizing the rosins and/or rosin derivatives of the present invention. Examples include, but are not limited to, the following: methylamine, dimethylamine, trimethylamine, triethylamine, morpholine, N-methylmorpholine, and combinations thereof. Suitable alkanolamines are those containing from two to about nine carbon atoms. Examples include, but are not limited to, the following: ethanolamine, diethanolamine, triethanolamine, isopropanolamine, diisopropanolamine, triisopropanolamine, N-methylethanolamine, dimethylethanolamine, diethylethanolamine, N,N-dimethylneopentanolamine, 1-amino-3-propanol, 2-amino-2-methyl-1,3-propanediol, and combinations thereof. Likewise, certain transition metal salts of most of the rosins and rosin derivatives of the present invention (such as the salts of zinc, copper, or zirconium) are also soluble in the presence of aqueous ammonia, amines, or alkanolamines and can, therefore, also be impregnated into the wood parts as aqueous liquid solutions. It is well within the ability of one skilled in the art to produce liquid solutions which contain the rosins, rosin derivatives, and additive resinous materials taught herein.

Fatty acid and its derivatives which are suitable for use in the present method include those fatty acids and their derivatives which contain a range of carbon atoms from about C₁₂ to about C₂₄; with the preferred range being from about C₁₆ to C₂₀. It is further preferred that the fatty acid be vegetable, animal, or tall oil based. It is most preferred that the fatty acid be tall oil based and contain less than 10% conjugated double bonds. As used herein the term “fatty acid” includes difunctional fatty acids. Derivatives of fatty acid include, but are not limited to, fatty ester, fatty amide, triglyceride, and alkyd.

The impregnation of wood parts with the hardening formulation of the present invention can be carried out at atmospheric pressure, but it is more advantageously carried out at elevated pressure. “Loading” is a synonym for the absorption of the impregnated hardening formulation by the wood parts and is—in the context of the present invention—also used for the respective technical impregnating process of immersing, preferably applying pressure and subsequent relieving of the pressure. Methods of treating wood with chromated copper arsenate solutions at elevated pressures are well known in the art. The same equipment (e.g., pressure vessels) used in such pesticide treatment methods can be readily adapted to the treatment of wood parts with the liquid hardening formulation of the present invention. Indeed, wood parts may be immersed in any suitable vessel which can be closed to generate the given excess pressure for the loading. Likewise, pressures which are typically used for the production of chromated copper arsenate treated wood are suitable for use in the present process. A preferred pressure range is from about 50 psi to about 200 psi.

Hardness of wood is generally measured according to the ASTM Standard D 143-94, Section 13, which is incorporated herein by reference. For heartwood type flooring, a hardness value of at least 1000 pounds force, preferably 1200 pounds force or greater, is desirable. Untreated yellow, non-heartwood pine generally has a hardness value below 800 pounds force.

The hardness of non-heartwood pine was measured before and after treatment with the hardening formulation of the present invention according to the ASTM Standard D 143-94, Section 13. (TABLE 1) The hardness of non-heartwood pine substantially increased after treatment with the hardening formulation of the present invention, reaching the hardness level of oak and making it more suitable for flooring use.

TABLE 1

| | | Hardness | Hardness |
|---|---|---|---|
| | | before | after |
| Hardening | | treatment | treatment |
| Formulation | Description | [lbs force] | [lbs force] |
| A | 60% Acrylic polymer; | 775 | 1,250 |
| | 40% Maleated | | |
| | rosin/fatty acid | | |
| B | 60% Acrylic polymer; | 767 | 1,308 |
| | 40% Fumarated | | |
| | rosin/fatty acid | | |
| C | 60% Acrylic polymer; | 739 | 1,262 |
| | 40% Unmodified | | |
| | rosin/fatty acid | | |

The hardening formulation A was used to treat the wood parts obtained from soft maple, black cherry, and oak. The hardness of the wood parts was measured before and after treatment according to the ASTM Standard D 143-94, Section 13. The hardness of wood boards and veneer was increased after treatment with the hardening formulation of the present invention. (TABLE 2)

TABLE 2

| | Hardness | Hardness |
|---|---|---|
| | before | after |
| | treatment | treatment |
| Wood part | [lbs force] | [lbs force] |
| Soft Maple Board | 1,134 | 2,041 |
| Black Cherry Board | 1,606 | 2,189 |
| Oak Veneer | 1,075 | 1,248 |

One embodiment of the present invention comprises the steps of:
(i) immersing at ambient temperature a wood part in a hardening formulation, wherein the non-volatile content of the hardening formulation comprises:
   (a) from about 40% to 100% by weight of a low molecular weight acrylic polymer; and
   (b) up to about 60% by weight of a rosin/fatty acid derivative, wherein the derivative comprises about 40% to 100% of a rosin or a rosin derivative and about 0% to 60% of a fatty acid or a fatty acid derivative;
(ii) loading the immersed wood part with the hardening formulation under excess pressure; and
(iii) removing the wood part from the hardening formulation.

A preferred embodiment of the present invention comprises the steps of:
(i) immersing at ambient temperature a wood part in a hardening formulation, wherein the non-volatile content of the hardening formulation comprises:
   (a) from about 40% to 100% by weight of a low molecular weight acrylic polymer; and
   (b) up to about 60% by weight of a rosin/fatty acid derivative, wherein the derivative comprises about 50% to 90% of a rosin or a rosin derivative and about 10% to 50% of a fatty acid or a fatty acid derivative;
(ii) loading the immersed the wood part with the hardening formulation under excess pressure; and
(iii) removing the wood part from the hardening formulation.

The upper limit of the applicable pressure in step (ii) mainly depends on the respective crushing strength of the wood part, as collapsing of the wood should be avoided. It is preferred to apply a pressure in the range of about 50 psi to about 200 psi. Where desired, a vacuum may be applied before or during step (i), or after step (ii) to support the efficiency of the loading.

In addition to being denser than the non-heartwood pine, heartwood pine is somewhat redder in color. This effect tends to be more pronounced in very old wood, which is often referred to in the art as “red heart.” Red heart tends to be the most commercially desirable type of pine heartwood for high-end applications (such as antique furniture reproduction manufacturing and the like). As rosin and most of its derivatives tend to darken on oxidation, the darker color of the heartwood can be mimicked in the treated non-heartwood pine by blowing air or oxygen through the rosin and/or rosin derivative used before employing it in the treatment process.

Where desired, at least one dye and/or pigment can be added to the hardening formulation of the present invention in order to impart a reddish or brownish color to the resulting simulated pine heartwood. Pigments are generally preferred due to their greater light fastness. Highly stable pigments such as yellow, red, or brown iron oxides are especially preferred so that the color is not lost on prolonged exposure to light (as when flooring is exposed to direct sunlight through a window, for example).

With suitable dyes and pigments in the hardening formulation of the present invention, the treated non-heartwood can provide simulated hardwood further than the heartwood pine.

Another embodiment of the present invention comprises the steps of:
(i) immersing at ambient temperature a wood part in a hardening formulation, wherein the non-volatile content of the hardening formulation comprises:
   (a) from about 40% to 100% by weight of a low molecular weight acrylic polymer;
   (b) up to about 60% by weight of a rosin/fatty acid derivative, wherein the derivative comprises about 40% to 100% of a rosin or a rosin derivative and about 0% to 60% of a fatty acid or a fatty acid derivative;
(ii) loading the immersed the wood part with the hardening formulation under excess pressure; and
(iii) removing the wood part from the hardening formulation.

A preferred embodiment of the present invention comprises the steps of:
(i) immersing at ambient temperature a wood part in a hardening formulation, wherein the non-volatile content of the hardening formulation comprises:
   (a) from about 40% to 100% by weight of a low molecular weight acrylic polymer; and
   (b) up to about 60% by weight of a rosin/fatty acid derivative, wherein the derivative comprises about 50% to 90% of a rosin or a rosin derivative and about 10% to 50% of a fatty acid or a fatty acid derivative;
(ii) loading the immersed the wood part with the hardening formulation under excess pressure; and
(iii) removing the wood part from the hardening formulation.

The following examples are provided to further illustrate the present invention and are not to be construed as limiting the invention in any manner.

### EXAMPLE

### Example 1

### Preparation of Maleated Rosin/Fatty Acid Derivative

Rosin was modified via Diels-Alder reaction by first heating the rosin at about 135° C., until it was molten. Maleic anhydride was added to the molten rosin, and the mixture was heated to about 180° C. The reaction was allowed to react for 2-4 hours. Once the reaction was completed, a tall oil fatty acid L-5 commercially available from MeadWestvaco Corp. was added to the modified rosin. The weight ratio of modified rosin to the fatty acid was 56 parts modified rosin to 44 parts fatty acid. The mixture was blended and allowed to cool down to room temperature.

### Example 2

### Preparation of Fumarated Rosin/Fatty Acid Derivative

Rosin was modified via Diels-Alder reaction by first heating the rosin at about 135° C., until it was molten. Fumaric anhydride was added to the molten rosin, and the mixture was heated to about 180° C. The reaction was allowed to react for 2-4 hours. Once the reaction was complete, a tall oil fatty acid L-5 commercially available from MeadWestvaco Corp. was added to the modified rosin. The weight ratio of modified rosin to the fatty acid was 56 parts modified rosin to 44 parts fatty acid. The mixture was blended and allowed to cool down to room temperature.

### Example 3

### Preparation of Rosin/Fatty Acid Derivative

Tall oil rosin commercially available from MeadWestvaco Corp. was heated to the molten state at about 135° C. The tall oil fatty acid L-5 commercially available from MeadWestvaco Corp. was added to the molten rosin. The weight ratio of rosin to the fatty acid was 56 parts rosin to 44 parts fatty acid. The mixture was blended and allowed to cool down to room temperature.

### Example 4

### Preparation of the Aqueous Solution of the Low Molecular Weight Acrylic Polymer

The aqueous solution of the Jonrez H-2702 acrylic resin, a low molecular weight acrylic polymer available from MeadWestvaco Corp., was prepared at about 20% solids by heating the acrylic resin Jonrez H-2702 in water to about 60° C. in the presence of ammonium hydroxide. Ammonium hydroxide solution (28-30% concentration) was added gradually in order to maintain the pH of the reaction mixture between 8 and 9. After completion of the solubilization, the acrylic resin solution was cooled to ambient temperature.

### Example 5

### Preparation of Hardening Formulation A

The hardening formulation A was prepared by blending the maleated rosin/fatty acid derivative of EXAMPLE 1 with the acrylic resin solution of EXAMPLE 4 at ambient temperature at the weight ratio of about 40 parts EXAMPLE 1 to about 60 parts EXAMPLE 4. The maleated rosin/fatty acid derivative of EXAMPLE 1 was gradually added to the acrylic solution of EXAMPLE 4. As the rosin/fatty acid derivative dissolved into the acrylic resin solution, additional ammonium hydroxide was added into the mixture in order to maintain the pH of the mixture at about between 8 and 9. After the addition of the rosin derivative, water was added to the mixture so that the solids content was about 26%.

### Example 6

### Preparation of Hardening Formulation B

The hardening formulation B was prepared by blending the fumarated rosin/fatty acid derivative of EXAMPLE 2 with the acrylic resin solution of EXAMPLE 4 at ambient temperature at the weight ratio of about 40 parts EXAMPLE 2 to about 60 parts EXAMPLE 4. The fumarated rosin/fatty acid derivative of EXAMPLE 2 was gradually added to the acrylic solution of EXAMPLE 4. As the rosin/fatty acid derivative dissolved into the acrylic resin solution, additional ammonium hydroxide was added into the mixture in order to maintain the pH of the mixture at about between 8 and 9. After the addition of the rosin/fatty acid derivative, water was added to the mixture so that the solids content was about 26%.

### Example 7

### Preparation of Hardening Formulation C

The hardening formulation C was prepared by blending the rosin/fatty acid derivative of EXAMPLE 3 with the acrylic resin solution of EXAMPLE 4 at ambient temperature at the weight ratio of about 40 parts EXAMPLE 3 to about 60 parts EXAMPLE 4. The unmodified rosin/fatty acid derivative of EXAMPLE 3 was gradually added to the acrylic solution of EXAMPLE 4. As the rosin/fatty acid derivative dissolved into the acrylic resin solution, additional ammonium hydroxide was added into the mixture in order to maintain the pH of the mixture at about between 8 and 9. After the addition of the rosin/fatty acid derivative, water was added to the mixture so that the solids content was about 26%.

### Example 8

### Treatment of Wood with the Hardening Formulation

A piece of wood part was placed in a cylindrical pressure vessel and subjected to a vacuum for twenty minutes. Then the hardening formulation was introduced into the vessel at ambient temperature, immersing the wood. The vessel was pressurized to 150 psi for thirty minutes. Thereafter, the pressure was released and the wood was removed from the pressure vessel. The treated wood was dried to a moisture content of about 12%.

Many modifications and variations of the present invention will be apparent to one of ordinary skill in the art in light of the above teachings. It is therefore understood that the scope of the invention is not to be limited by the foregoing description, but rather is to be defined by the claims appended hereto.

What is claimed is:

1. Hardened wood comprising a wood part impregnated with from about 40% to 100% by weight of a low molecular weight acrylic polymer; and up to about 60% by weight of a rosin/fatty acid derivative.

2. The hardened wood of claim 1, wherein the wood part is a member selected from the group consisting of flooring strips, furniture parts, boards, beams, panels, veneers, frames, construction elements, plywood panels, and laminates.

3. The hardened wood of claim 1, wherein the wood part is a member selected from the group consisting of Abies, Cathaya, Cedrus, Keteleeria, Larix, Nothotsuga, Picea, Pinus, Pseudolarix, Pseudotsuga, and Tsuga.

4. The hardened wood of claim 1, wherein the wood part comprises at least non-heartwood.

5. The hardened wood of claim 4, wherein the non-heartwood part is a member selected from the group consisting of Pinus palustris, Pinus echinata, Pinus taeda, Pinus elliottii, Pinus serotina, and hybrids thereof.

6. The hardened wood of claim 1, wherein the wood part comprises heartwood.

7. The hardened wood of claim 1, wherein the wood part is a member selected from the group consisting of Prunus, Acer, and Quercus.

8. The hardened wood of claim 1, wherein the low molecular weight acrylic polymer has a weight average molecular weight of from about 2,000 to about 16,500.

9. The hardened wood of claim 1, wherein the low molecular weight acrylic polymer has an acid number of from about 50 to about 280.

10. The hardened wood of claim 1, wherein the low molecular weight acrylic polymer comprises members selected from the group consisting of the polymerization reaction product of:
(a) a member selected from the group consisting of acrylic acid, methacrylic acid, fumaric acid, crotonic acid, itaconic acid, maleic acid, maleic anhydride, carboxylic acrylics, and combinations thereof, and
(b) a member selected from the group consisting of vinylic monomers and combinations thereof.

11. The hardened wood of claim 10, wherein the vinyl monomer is selected from the group consisting of styrenic monomer, acrylic monomer, methacrylic monomer, ethylenic monomer, and combinations thereof.

12. The hardened wood of claim 11, wherein the acrylic monomer is selected from the group consisting of acrylic acid, methacrylic acid, acrylic acid ester, methacrylic acid ester, derivative of acrylic acid, derivative of methacrylic acid, and combinations thereof.

13. The hardened wood of claim 12, wherein the derivative of acrylic acid is selected from the group consisting of acrylic acid salt, acrylonitrile, acrylamide, methyl alpha-chloroacrylate, methyl 2-cyanoacrylate, N-ethylacrylamide, N,N-diethylacrylamide acrolein, and combinations thereof.

14. The hardened wood of claim 12, wherein the derivative of methacrylic acid is selected from the group consisting of methacrylic acid salt, methacrylonitrile, methacrylamide, N-methylmethacrylamide, N-ethylmethacrylamide, N,N-diethymethacrylamide, N,N-dimethylmethacrylamide, N-phenyl-methacrylamide, methacrolein, and combinations thereof.

15. The hardened wood of claim 1, wherein the rosin/fatty acid derivative comprises:
(a) from about 40% to 100% of a rosin or a rosin derivative; and
(b) from about 0% to 60% of a fatty acid or a fatty acid derivative

16. The hardened wood of claim 15, wherein the rosin is selected from the group consisting of tall oil rosin, gum rosin, wood rosin, and combinations thereof.

17. The hardened wood of claim 15, wherein the rosin derivative is selected from the group consisting of hydrogenated rosins, disproportionated rosins, formaldehyde-treated rosins, dimerized rosins, polymerized rosin, fumarated rosins, maleated rosins, styrenated rosins, phenolic-modified rosins, acrylic-modified rosins, hydrocarbon-modified rosins, rosin-vinylic copolymers, rosin salts, hydrogenated rosin salts, disproportionated rosin salts, formaldehyde-treated rosin salts, dimerized rosin salts, polymerized rosin salts, fumarated rosin salts, maleated rosin salts, styrenated rosin salts, phenolic-modified rosin salts, acrylic-modified rosin salts, hydrocarbon-modified rosin salts, rosin-vinylic copolymer salts, rosin esters, hydrogenated rosin esters, disproportionated rosin esters, formaldehyde-treated rosin esters, dimerized rosin esters, polymerized rosin esters, fumarated rosin esters, maleated rosin esters, styrenated rosin esters, phenolic-modified rosin esters, acrylic-modified rosin esters, hydrocarbon-modified rosin esters, rosin-vinylic copolymer esters, rosin amides, hydrogenated rosin amides, disproportionated rosin amides, formaldehyde-treated rosin amides, dimerized rosin amides, polymerized rosin amides, fumarated rosin amides, maleated rosin amides, styrenated rosin amides, phenolic-modified rosin amides, acrylic-modified rosin amides, hydrocarbon-modified rosin amides, rosin-vinylic copolymer amides, and combinations thereof.

18. The hardened wood of claim 15, wherein the fatty acid is a member selected from the group consisting of fatty acid containing from 12 to 24 carbon atoms and combinations thereof.

19. The hardened wood of claim 15, wherein the fatty acid derivative is a member selected from the group consisting fatty ester, fatty amide, triglyceride, and alkyd of fatty acid containing from 12 to 24 carbon atoms and combinations thereof.

20. The hardened wood of claim 1, wherein the rosin/fatty acid derivative comprises:
(a) from about 50% to 90% of a rosin or a rosin derivative; and
(b) from about 10% to 50% of a fatty acid or a fatty acid derivative.

21. The hardened wood of claim 20, wherein the rosin is selected from the group consisting of tall oil rosin, gum rosin, wood rosin, and combinations thereof.

22. The hardened wood of claim 20, wherein the rosin derivative is selected from the group consisting of hydrogenated rosins, disproportionated rosins, formaldehyde-treated rosins, dimerized rosins, polymerized rosin, fumarated rosins, maleated rosins, styrenated rosins, phenolic-modified rosins, acrylic-modified rosins, hydrocarbon-modified rosins, rosin-vinylic copolymers, rosin salts, hydrogenated rosin salts, disproportionated rosin salts, formaldehyde-treated rosin salts, dimerized rosin salts, polymerized rosin salts, fumarated rosin salts, maleated rosin salts, styrenated rosin salts, phenolic-modified rosin salts, acrylic-modified rosin salts, hydrocarbon-modified rosin salts, rosin-vinylic copolymer salts, rosin esters, hydrogenated rosin esters, disproportionated rosin esters, formaldehyde-treated rosin esters, dimerized rosin esters, polymerized rosin esters, fumarated rosin esters, maleated rosin esters, styrenated rosin esters, phenolic-modified rosin esters, acrylic-modified rosin esters, hydrocarbon-modified rosin esters, rosin-vinylic copolymer esters, rosin amides, hydrogenated rosin amides, disproportionated rosin amides, formaldehyde-treated rosin amides, dimerized rosin amides, polymerized rosin amides, fumarated rosin amides, maleated rosin amides, styrenated rosin amides, phenolic-modified rosin amides, acrylic-modified rosin amides, hydrocarbon-modified rosin amides, rosin-vinylic copolymer amides, and combinations thereof.

23. The hardened wood of claim 20, wherein the fatty acid is a member selected from the group consisting of fatty acid containing from 12 to 24 carbon atoms and combinations thereof.

24. The hardened wood of claim 20, wherein the fatty acid derivative is a member selected from the group consisting fatty ester, fatty amide, triglyceride, and alkyd of fatty acid containing from 12 to 24 carbon atoms and combinations thereof.

25. The hardened wood of claim 1, wherein the impregnating formulation for the wood further comprises at least one member selected from the group consisting of dyes, pigments, and combinations thereof.

26. The hardened wood of claim 1, characterized by a hardness value of at least 1000 pounds force.

27. A process for producing hardened wood, comprising the step of impregnating a wood part by immersing the wood part at ambient temperature in a hardening liquid formulation, wherein a non-volatile content of the liquid formulation comprises:
(a) from about 40% to 100% by weight of a low molecular weight acrylic polymer; and
(b) up to about 60% by weight of a rosin/fatty acid derivative.

28. The process of claim 27, wherein the wood part is a member selected from the group consisting of flooring strips, furniture parts, boards, beams, panels, veneers, frames, construction elements, plywood panels, and laminates.

29. The hardened wood of claim 27, wherein the wood part is a member selected from the group consisting of Abies, Cathaya, Cedrus, Keteleeria, Larix, Nothotsuga, Picea, Pinus, Pseudolarix, Pseudotsuga, and Tsuga.

30. The hardened wood of claim 27, wherein the wood part comprises at least non-heartwood.

31. The hardened wood of claim 30, wherein the non-heartwood is a member selected from the group consisting of Pinus palustris, Pinus echinata, Pinus taeda, Pinus elliottii, Pinus serotina, and hybrids thereof.

32. The hardened wood of claim 27, wherein the wood part comprises heartwood.

33. The hardened wood of claim 27, wherein the wood part is a member selected from the group consisting of Prunus, Acer, and Quercus.

34. The process of claim 27, wherein the low molecular weight acrylic polymer has a weight average molecular weight of from about 2,000 to about 16,500.

35. The process of claim 27, wherein the low molecular weight acrylic polymer has an acid number of from about 50 to about 280.

36. The process of claim 27, wherein the low molecular weight acrylic polymer comprises members selected from the group consisting of the polymerization reaction product of:
(a) a member selected from the group consisting of acrylic acid, methacrylic acid, fumaric acid, crotonic acid, itaconic acid, maleic acid, maleic anhydride, carboxylic acrylics, and combinations thereof, and
(b) a member selected from the group consisting of vinylic monomers and combinations thereof.

37. The process of claim 36, wherein the vinyl monomer is selected from the group consisting of styrenic monomer, acrylic monomer, methacrylic monomer, ethylenic monomer, and combinations thereof.

38. The process of claim 37, wherein the acrylic monomer is selected from the group consisting of acrylic acid, methacrylic acid, acrylic acid ester, methacrylic acid ester, derivative of acrylic acid, derivative of methacrylic acid, and combinations thereof.

39. The process of claim 38, wherein the derivative of acrylic acid is selected from the group consisting of acrylic acid salt, acrylonitrile, acrylamide, methyl alpha-chloroacrylate, methyl 2-cyanoacrylate, N-ethylacrylamide, N,N-diethylacrylamide acrolein, and combinations thereof.

40. The process of claim 38, wherein the derivative of methacrylic acid is selected from the group consisting of methacrylic acid salt, methacrylonitrile, methacrylamide, N-methylmethacrylamide, N-ethylmethacrylamide, N,N-diethymethacrylamide, N,N-dimethylmethacrylamide, N-phenyl-methacrylamide, methacrolein, and combinations thereof.

41. The process of claim 27, wherein the rosin/fatty acid derivative comprises:
(a) from about 40% to 100% of a rosin or a rosin derivative; and
(b) from about 0% to 60% of a fatty acid or a fatty acid derivative.

42. The process of claim 41, wherein the rosin is selected from the group consisting of tall oil rosin, gum rosin, wood rosin, and combinations thereof.

43. The process of claim 41, wherein the rosin derivative is selected from the group consisting of hydrogenated rosins, disproportionated rosins, formaldehyde-treated rosins, dimerized rosins, polymerized rosin, fumarated rosins, maleated rosins, styrenated rosins, phenolic-modified rosins, acrylic-modified rosins, hydrocarbon-modified rosins, rosin-vinylic copolymers, rosin salts, hydrogenated rosin salts, disproportionated rosin salts, formaldehyde-treated rosin salts, dimerized rosin salts, polymerized rosin salts, fumarated rosin salts, maleated rosin salts, styrenated rosin salts, phenolic-modified rosin salts, acrylic-modified rosin salts, hydrocarbon-modified rosin salts, rosin-vinylic copolymer salts, rosin esters, hydrogenated rosin esters, disproportionated rosin esters, formaldehyde-treated rosin esters, dimerized rosin esters, polymerized rosin esters, fumarated rosin esters, maleated rosin esters, styrenated rosin esters, phenolic-modified rosin esters, acrylic-modified rosin esters, hydrocarbon-modified rosin esters, rosin-vinylic copolymer esters, rosin amides, hydrogenated rosin amides, disproportionated rosin amides, formaldehyde-treated rosin amides, dimerized rosin amides, polymerized rosin amides, fumarated rosin amides, maleated rosin amides, styrenated rosin amides, phenolic-modified rosin amides, acrylic-modified rosin amides, hydrocarbon-modified rosin amides, rosin-vinylic copolymer amides, and combinations thereof.

44. The process of claim 41, wherein the fatty acid is a member selected from the group consisting of fatty acid containing from 12 to 24 carbon atoms and combinations thereof.

45. The process of claim 41, wherein the fatty acid derivative is a member selected from the group consisting fatty ester, fatty amide, triglyceride, and alkyd of fatty acid containing from 12 to 24 carbon atoms and combinations thereof.

46. The process of claim 27, wherein the rosin/fatty acid derivative comprises:
(a) from about 50% to 90% of a rosin or a rosin derivative; and
(b) from about 10% to 50% of a fatty acid or a fatty acid derivative.

47. The process of claim 46, wherein the rosin is selected from the group consisting of tall oil rosin, gum rosin, wood rosin, and combinations thereof.

48. The process of claim 46, wherein the rosin derivative is selected from the group consisting of hydrogenated rosins, disproportionated rosins, formaldehyde-treated rosins, dimerized rosins, polymerized rosin, fumarated rosins, maleated rosins, styrenated rosins, phenolic-modified rosins, acrylic-modified rosins, hydrocarbon-modified rosins, rosin-vinylic copolymers, rosin salts, hydrogenated rosin salts, disproportionated rosin salts, formaldehyde-treated rosin salts, dimerized rosin salts, polymerized rosin salts, fumarated rosin salts, maleated rosin salts, styrenated rosin salts, phenolic-modified rosin salts, acrylic-modified rosin salts, hydrocarbon-modified rosin salts, rosin-vinylic copolymer salts, rosin esters, hydrogenated rosin esters, disproportionated rosin esters, formaldehyde-treated rosin esters, dimerized rosin esters, polymerized rosin esters, fumarated rosin esters, maleated rosin esters, styrenated rosin esters, phenolic-modified rosin esters, acrylic-modified rosin esters, hydrocarbon-modified rosin esters, rosin-vinylic copolymer esters, rosin amides, hydrogenated rosin amides, disproportionated rosin amides, formaldehyde-treated rosin amides, dimerized rosin amides, polymerized rosin amides, fumarated rosin amides, maleated rosin amides, styrenated rosin amides, phenolic-modified rosin amides, acrylic-modified rosin amides, hydrocarbon-modified rosin amides, rosin-vinylic copolymer amides, and combinations thereof.

49. The process of claim 46, wherein the fatty acid is a member selected from the group consisting of fatty acid containing from 12 to 24 carbon atoms and combinations thereof.

50. The process of claim 46, wherein the fatty acid derivative is a member selected from the group consisting fatty ester, fatty amide, triglyceride, and alkyd of fatty acid containing from 12 to 24 carbon atoms and combinations thereof.

51. The process of claim 27, wherein the hardening formulation further comprises at least one member selected from the group consisting of dyes, pigments, and combinations thereof.

52. The process of claim 27, wherein the hardened wood part has a hardness of at least 1000 pounds force.

53. A process for producing hardened wood, comprising the steps of:
(i) immersing at ambient temperature a wood part in a hardening formulation, wherein the non-volatile content of the hardening formulation comprises:
(a) from about 40% to 100% by weight of a low molecular weight acrylic polymer; and
(b) up to about 60% by weight of a rosin/fatty acid derivative;
(ii) loading the immersed the wood part with the hardening formulation under excess pressure; and
(ii) removing the wood part from the hardening formulation.

54. The process of claim 53, wherein the wood part is a member selected from the group consisting of flooring strips, furniture parts, boards, beams, panels, veneers, frames, construction elements, plywood panels, and laminates.

55. The process of claim 53, wherein the wood part is a member selected from the group consisting of Abies, Cathaya, Cedrus, Keteleeria, Larix, Nothotsuga, Picea, Pinus, Pseudolarix, Pseudotsuga, and Tsuga.

56. The process of claim 53, wherein the wood part comprises at least non-heartwood.

57. The process of claim 56, wherein the non-heartwood is a member selected from the group consisting of Pinus palustris, Pinus echinata, Pinus taeda, Pinus elliottii, Pinus serotina, and hybrids thereof.

58. The process of claim 53, wherein the wood part comprises heartwood.

59. The process of claim 53, wherein the wood part is a member selected from the group consisting of Prunus, Acer, and Quercus.

60. The process of claim 53, wherein a vacuum is applied before or during step (i).

61. The process of claim 53, wherein a vacuum is applied after step (ii).

62. The process of claim 53, wherein a pressure in the range of about 50 psi to about 200 psi is applied in step (ii).

63. The hardened wood of claim 53.

64. The hardened wood of claim 53, wherein the wood part is a member selected from the group consisting of flooring strips, furniture parts, boards, beams, panels, veneers, frames, construction elements, plywood panels, and laminates.

65. The hardened wood of claim 53, wherein the wood part is from a member selected from the group consisting of Abies, Cathaya, Cedrus, Keteleeria, Larix, Nothotsuga, Picea, Pinus, Pseudolarix, Pseudotsuga, and Tsuga.

66. The hardened wood of claim 53, wherein the wood part comprises at least non-heartwood.

67. The hardened wood of claim 66, wherein the non-heartwood part is from a member selected from the group consisting of Pinus palustris, Pinus echinata, Pinus taeda, Pinus elliottii, Pinus serotina, and hybrids thereof.

68. The hardened wood of claim 53, wherein the wood part comprises heartwood.

69. The hardened wood of 53, wherein the wood part is a member selected from the group consisting of Prunus, Acer, and Quercus.

70. The hardened wood part of claim 53, characterized by a hardness value of at least 1000 pounds force.

71. The hardened wood of claim 53, characterized by a hardness value of at least 1200 pounds force.

72. Hardening liquid formulation, characterized by a non-volatile content comprises from about 40% to 100% by weight of a low molecular weight acrylic polymer; and up to about 60% by weight of a rosin/fatty acid derivative.

73. The hardening liquid formulation of claim 72, wherein the low molecular weight acrylic polymer has a weight average molecular weight of from about 2,000 to about 16,500.

74. The hardening liquid formulation of claim 72, wherein the low molecular weight acrylic polymer has an acid number of from about 50 to about 280.

75. The hardening liquid formulation of claim 72, wherein the low molecular weight acrylic polymer comprises members selected from the group consisting of the polymerization reaction product of:
(a) a member selected from the group consisting of acrylic acid, methacrylic acid, fumaric acid, crotonic acid, itaconic acid, maleic acid, maleic anhydride, carboxylic acrylics, and combinations thereof, and
(b) a member selected from the group consisting of vinylic monomers and combinations thereof.

76. The hardening liquid formulation of claim 75, wherein the vinyl monomer is selected from the group consisting of styrenic monomer, acrylic monomer, methacrylic monomer, ethylenic monomer, and combinations thereof.

77. The hardening liquid formulation of claim 76, wherein the acrylic monomer is selected from the group consisting of acrylic acid, methacrylic acid, acrylic acid ester, methacrylic acid ester, derivative of acrylic acid, derivative of methacrylic acid, and combinations thereof.

78. The hardening liquid formulation of claim 77, wherein the derivative of acrylic acid is selected from the group consisting of acrylic acid salt, acrylonitrile, acrylamide, methyl alpha-chloroacrylate, methyl 2-cyanoacrylate, N-ethylacrylamide, N,N-diethylacrylamide acrolein, and combinations thereof.

79. The hardening liquid formulation of claim 77, wherein the derivative of methacrylic acid is selected from the group consisting of methacrylic acid salt, methacrylonitrile, methacrylamide, N-methylmethacrylamide, N-ethylmethacrylamide, N,N-diethymethacrylamide, N,N-dimethylmethacrylamide, N-phenyl-methacrylamide, methacrolein, and combinations thereof.

80. The hardening liquid formulation of claim 72, wherein the rosin/fatty acid derivative comprises:
(a) from about 40% to 100% of a rosin or a rosin derivative; and
(b) from about 0% to 60% of a fatty acid or a fatty acid derivative

81. The hardening liquid formulation of claim 80, wherein the rosin is selected from the group consisting of tall oil rosin, gum rosin, wood rosin, and combinations thereof.

82. The hardening liquid formulation of claim 80, wherein the rosin derivative is selected from the group consisting of hydrogenated rosins, disproportionated rosins, formaldehyde-treated rosins, dimerized rosins, polymerized rosin, fumarated rosins, maleated rosins, styrenated rosins, phenolic-modified rosins, acrylic-modified rosins, hydrocarbon-modified rosins, rosin-vinylic copolymers, rosin salts, hydrogenated rosin salts, disproportionated rosin salts, formaldehyde-treated rosin salts, dimerized rosin salts, polymerized rosin salts, fumarated rosin salts, maleated rosin salts, styrenated rosin salts, phenolic-modified rosin salts, acrylic-modified rosin salts, hydrocarbon-modified rosin salts, rosin-vinylic copolymer salts, rosin esters, hydrogenated rosin esters, disproportionated rosin esters, formaldehyde-treated rosin esters, dimerized rosin esters, polymerized rosin esters, fumarated rosin esters, maleated rosin esters, styrenated rosin esters, phenolic-modified rosin esters, acrylic-modified rosin esters, hydrocarbon-modified rosin esters, rosin-vinylic copolymer esters, rosin amides, hydrogenated rosin amides, disproportionated rosin amides, formaldehyde-treated rosin amides, dimerized rosin amides, polymerized rosin amides, fumarated rosin amides, maleated rosin amides, styrenated rosin amides, phenolic-modified rosin amides, acrylic-modified rosin amides, hydrocarbon-modified rosin amides, rosin-vinylic copolymer amides, and combinations thereof.

83. The hardening liquid formulation of claim 80, wherein the fatty acid is a member selected from the group consisting of fatty acid containing from 12 to 24 carbon atoms and combinations thereof.

84. The hardening liquid formulation of claim 80, wherein the fatty acid derivative is a member selected from the group consisting fatty ester, fatty amide, triglyceride, and alkyd of fatty acid containing from 12 to 24 carbon atoms and combinations thereof.

85. The hardening liquid formulation of claim 72, wherein the rosin/fatty acid derivative comprises:
(a) from about 50% to 90% of a rosin or a rosin derivative; and
(b) from about 10% to 50% of a fatty acid or a fatty acid derivative.

86. The hardening liquid formulation of claim 85, wherein the rosin is selected from the group consisting of tall oil rosin, gum rosin, wood rosin, and combinations thereof.

87. The hardening liquid formulation of claim 85, wherein the rosin derivative is selected from the group consisting of hydrogenated rosins, disproportionated rosins, formaldehyde-treated rosins, dimerized rosins, polymerized rosin, fumarated rosins, maleated rosins, styrenated rosins, phenolic-modified rosins, acrylic-modified rosins, hydrocarbon-modified rosins, rosin-vinylic copolymers, rosin salts, hydrogenated rosin salts, disproportionated rosin salts, formaldehyde-treated rosin salts, dimerized rosin salts, polymerized rosin salts, fumarated rosin salts, maleated rosin salts, styrenated rosin salts, phenolic-modified rosin salts, acrylic-modified rosin salts, hydrocarbon-modified rosin salts, rosin-vinylic copolymer salts, rosin esters, hydrogenated rosin esters, disproportionated rosin esters, formaldehyde-treated rosin esters, dimerized rosin esters, polymerized rosin esters, fumarated rosin esters, maleated rosin esters, styrenated rosin esters, phenolic-modified rosin esters, acrylic-modified rosin esters, hydrocarbon-modified rosin esters, rosin-vinylic copolymer esters, rosin amides, hydrogenated rosin amides, disproportionated rosin amides, formaldehyde-treated rosin amides, dimerized rosin amides, polymerized rosin amides, fumarated rosin amides, maleated rosin amides, styrenated rosin amides, phenolic-modified rosin amides, acrylic-modified rosin amides, hydrocarbon-modified rosin amides, rosin-vinylic copolymer amides, and combinations thereof

88. The hardening liquid formulation of claim 85, wherein the fatty acid is a member selected from the group consisting of fatty acid containing from 12 to 24 carbon atoms and combinations thereof.

89. The hardening liquid formulation of claim 85, wherein the fatty acid derivative is a member selected from the group consisting fatty ester, fatty amide, triglyceride, and alkyd of fatty acid containing from 12 to 24 carbon atoms and combinations thereof.

90. The hardening liquid formulation of claim 72, further comprising at least one member selected from the group consisting of dyes, pigments, and combinations thereof.
